(19) United States
(12) Patent Application Publication
(10) Pub. No.: US 2006/0271398 A1
(43) Pub. Date: Nov. 30, 2006

(54) Web-based pharmacist

(76) Inventor: Jamie Belcastro, Springfield, VA (US)

Correspondence Address: LITMAN LAW OFFICES, LTD, PO BOX 15035, CRYSTAL CITY STATION, ARLINGTON, VA, 22215, US

(21) Appl. No.: 11/137,535

(22) Filed: May 26, 2005

(51) Int. Cl. G06Q 10/00; G07F 7/00; G06F 3/00

(52) U.S. Cl. 705/2; 705/27; 715/706

(57) ABSTRACT

The Web-based pharmacist is a system and method that provides for an information provider computing resource being the target of a URL link on a pharmacy Web page. The link directs at least one end user of the pharmacy Web page to an information provider Web page, using information provider computing resources where the end user can request a drug presentation about pharmacy drugs. The information provider computing resource has enough storage for the drug information, and enough storage and retrieval capability for the drug presentation. The information may be presented by streaming audio and streaming video, and may be presented through an animated, three-dimensional avatar.

### BACKGROUND OF THE INVENTION

1. Field of the Invention

The present invention relates to a method of presenting multimedia information that may be streamed to at least one requesting end user, and more particularly, to a Web-based pharmacist employing a computerized method that minimizes the use of computer resources under the control of a supplier of products or services so that the supplier can achieve the objective of presenting information about the products and services by linking an end user to computer resources managed by an information provider. The information provider manages information provider databases and other information provider computer resources for the storage, retrieval and multimedia streaming of supplier product and service information upon request by the end user.

2. Description of the Related Art

Suppliers of products and services desire to continuously improve their processes in order to satisfy an increasing number of potential and existing customers. Information about a supplier's products and/or services plays an ever increasingly important role in the acquisition of new customers, and the retention of existing customers. The information about supplier products and services can be viewed as customer education. If a customer feels that he or she is getting a quality education regarding the products or services the customer is interested in, the customer is likely to reward the supplier with more orders and customer loyalty.

Suppliers are generally in the business of supplying their product or service, and not in the business of consumer education about the product or services. Therefore, suppliers would rather not expend personnel for computer programming, integration graphic design, internet bandwidth, and the like, in order to support a platform that provides information about the supplier products twenty-four hours a day, seven days per week. Educating the consumer, as well as providing a product to the consumer, would require that the supplier allocate additional resources, both computing and personnel, to the consumer education effort. Suppliers attempting to streamline their business processes would rather outsource the consumer education task to another entity that can handle the task more efficiently. This is particularly true in the field of health care, and particularly information relating to drugs and pharmaceuticals.

Thus, a Web-based pharmacist solving the aforementioned problems is desired.

### SUMMARY OF THE INVENTION

The Web-based pharmacist is a method and a system that provides for an information provider computing resource being the target of a URL link on a pharmacy Web page to provide consumer information and education regarding products. The link directs an end user of the pharmacy Web page to an information provider Web page, using information provider computing resources where the end user can request a drug presentation about pharmacy drugs. The information provider computing resource has enough storage for the drug information, and enough storage and retrieval capability for the drug presentation.

Since the drug presentation uses the information provider computing resource, no additional bandwidth or other resources are required of a pharmacy computing resource. Additionally, in practice, the presentation method of the present invention has the capability of saving on non-computing resources, such as personnel, who, but for the present invention, would have been allocated to the pharmacy in support of the drug presentation. In addition, the information provider's computing resources are designed to handle the storage and retrieval of multimedia presentation information in a database. As well the invention provides for interaction between a patient and web based pharmacist for pharmacies lacking a public physical storefront, i.e., mail order and internet pharmacies.

The present invention provides for multimedia presentation information streaming and synchronization to present a coherent multimedia presentation with minimal download times to the end user. For an enhanced version of the multimedia presentation, avatar data may be streamed and synchronized. According to the present invention, the avatar, when representing a pharmacist, provides a presentation in a Web site with the same look and feel as the supplier Web site, e.g., the pharmacy Web site. In addition, the present invention provides the pharmacy with the capability to review statistics regarding usage by the pharmacy's customers, i.e., end users. Thus, the pharmacy benefits from market intelligence gleaned from the statistics review capability provided by the present invention.

These and other features of the present invention will become readily apparent upon further review of the following specification and drawings.

### BRIEF DESCRIPTION OF THE DRAWINGS

FIG. 1 is a block diagram of the network components for a Web-based pharmacist according to the present invention.

FIG. 2 is a block diagram depicting a link and a reverse link between a supplier and an information provider in a Web-based pharmacist according to the present invention.

FIG. 3 is a block diagram showing the information flow into the presentation platform of a Web-based pharmacist according to the present invention.

FIG. 4 is a chart exemplifying a report of a number of presentations viewed vs. day of week in a Web-based pharmacist according to the present invention.

FIG. 5 is a chart exemplifying a report of frequency of drug presentations viewed vs. the drug that was viewed in a Web-based pharmacist according to the present invention.

FIG. 6 is a chart exemplifying a report of a number of presentations viewed vs. the viewing month in a Web-based pharmacist according to the present invention.

FIG. 7 is a screen shot showing an exemplary Web page showing drug choice options and end user presentation controls in a Web-based pharmacist according to the present invention.

FIG. 8 is a screen shot showing an exemplary Web page with a search results dialog box in a Web-based pharmacist according to the present invention.

FIG. 9 is a screen shot showing an exemplary Web page with a pulldown menu for presentation section selection in a Web-based pharmacist according to the present invention.

Similar reference characters denote corresponding features consistently throughout the attached drawings.

### DETAILED DESCRIPTION OF THE PREFERRED EMBODIMENT

The present invention is a Web-based pharmacist that includes a system and method by which a pharmacist or pharmaceutical supplier may educate the consumer over a computer network, and particularly the Internet, through Web site links to an information provider capable of delivering streaming audio text and video files, including the use of avatars for presentation purposes. Although the invention is particularly useful in the context of providing information about pharmaceuticals, the teachings of the present invention may be applied more generally to other products and services, so that the description herein may include both general terminology and terminology directed towards the particular embodiment or application directed towards pharmaceuticals.

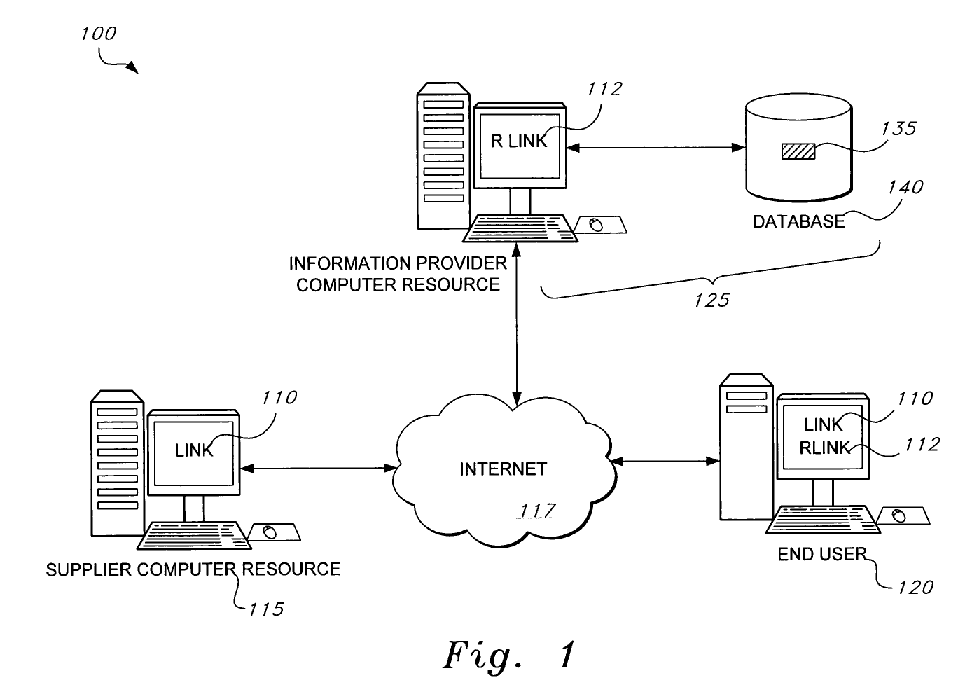

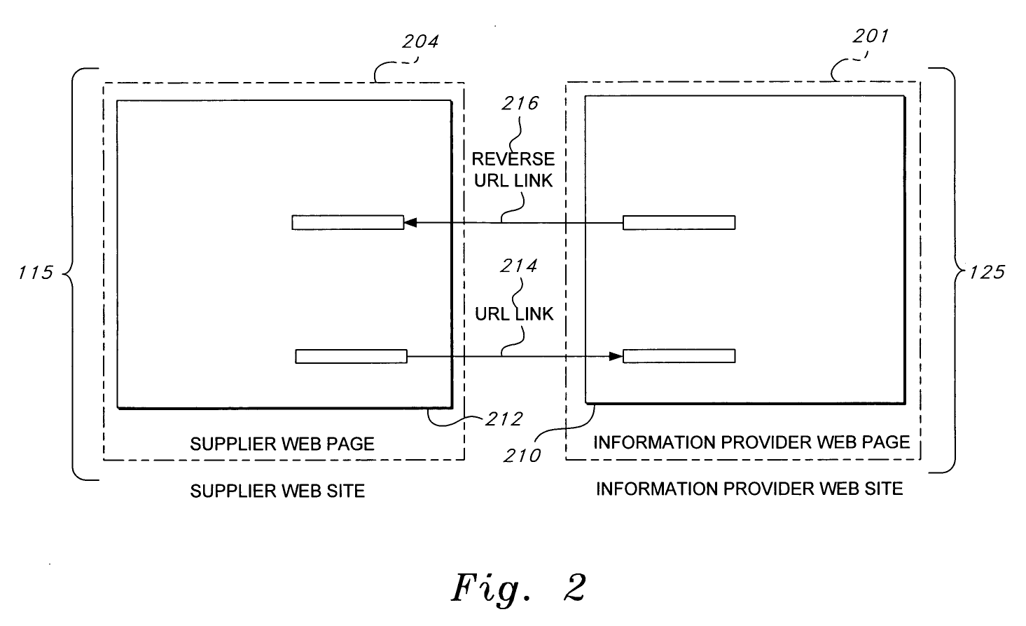

As shown in FIG. 1, the Web-based pharmacist is a system that operates in a computer network environment 100, wherein at least one link 110 is provided at the supplier's computing resource 115 directing an end user 120 to a computing resource of an information provider 125. It should also be noted that the link 110 may be of any type, including, but not limited to, a hypertext Uniform Resource Locator (URL) link 214, as shown diagrammatically in FIG. 2. When the end user 120 selects the link 110, the end user 120 is then presented, either automatically or in response to the end user's request, with at least one presentation 135.

It should be understood, however, that the presentation utilizes the computing resource of the information provider 125. It is also noted that, according to the present invention, the computing resource of the information provider 125 may be connected to the Internet 117 in order to deliver the presentation to the end user. While the supplier's computing resource 115 may also be connected to the Internet 117, no bandwidth or other related computer resource of the supplier's computing resource 115 is required to deliver the presentation. Additionally, a reverse link 112 is also provided for directing the end user from the computing resource of the information provider back to the computing resource of the supplier. As shown in FIG. 2, the reverse link may also be a reverse URL link 216.

Again, referring to FIG. 1, it is shown that according to the present invention, the information related to the supplier is stored in a database 140 for later retrieval for display of the presentation in response to a selection by the end user. In the embodiment wherein the supplier is a pharmacy, the information related to the supplier comprises drug information, the presentation(s) 135 comprises a drug presentation, and the end user is a patient. In addition, the drug information can be updated quarterly by the information provider to reflect changes in the U.S. Food and Drug Administration Drug Information Monograph. Such updates are done within the information provider database. According to the present invention, the drug information may be provided using a question and answer format, and may be based on a medication teaching manual. It should also be noted that the database 140 is not a part of the supplier's computer resource 115, because the storing of the information related to the supplier is accomplished on a server hosted by the information provider or third party. Thus storage, i.e., disk space need not be allocated to the supplier's computer resource 115 for the presentation related information.

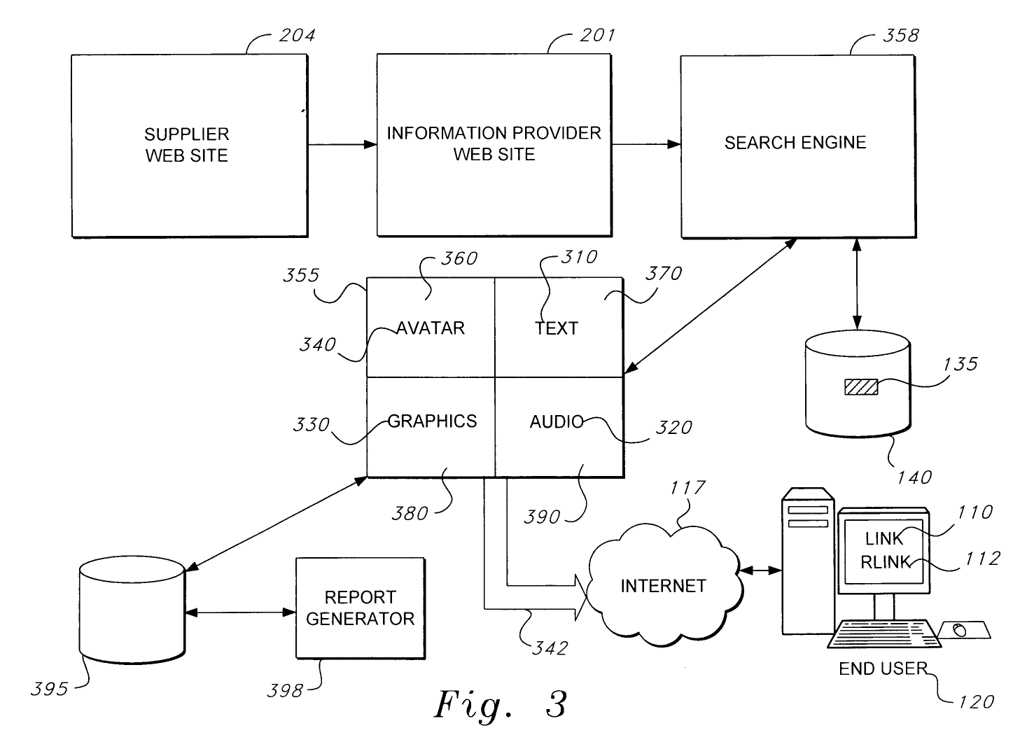

As shown in FIG. 3, the presentation format may vary from a single stream of text 310, audio 320, graphic 330, or avatar data 340 to a synchronized presentation of multiple separate data streams 342 comprising a subset or all of the text 310, audio 320, graphic 330 and avatar data 340 to present a coherent, or, enhanced coherent (with synchronized, streaming avatar data), multimedia presentation with the advantage of providing minimal download times to the end user 120. It should be understood that, according to the present invention, the capability to synchronize a presentation format encompasses internal synchronization of the presentation format with a selected cue point selected by the end user 120, as well as synchronization with the other presentation formats, e.g., graphics is synchronized to text, speech is synchronized to text, and an avatar is synchronized to speech. A presentation platform comprises at least four processing components, i.e., an avatar processor 360, a text processor 370, a graphics processor 380, and a speech processor 390 for creating and synchronizing the single stream of text 310, audio 320, graphic 330, and avatar data 340 components.

According to the present invention, the avatar 710, as shown in FIG. 7, may comprise a lifelike, realistic rendition of a pharmacist. The avatar 710 is designed to deliver the speech part of the presentation to the end user. Unlike traditional animation, realistic facial movement in the avatar 710 is achieved by functionalized scaling of parts of the face, wherein each part of the face is a separate graphic.

The functionalized randomization and customizable facial component variables provided by the present invention comprise: (1) maximum and minimum head turn time, which defines the maximum and minimum speed of head turning setting low and high thresholds for randomized head turning; (2) maximum and minimum head rotation time, which defines the maximum and minimum interval of head rotation that sets low and high thresholds for randomized head rotation; (3) Reset/Rotate Pause, which defines a maximum length of pause before a move to a new head rotation sequence, sets thresholds for randomized pausing, includes other functionalized variables for a determination of pauses and resets accordingly with randomization integrated; (4) eyebrow play and total eyebrow animations, setting a ceiling from which to chose a random number that triggers one of an expandable set of eyebrow animations; (5) eye blink rate, which determines how frequently the eyes blink; and (7) maximum/minimum head rotation by degree, which sets minimum and maximum degree of head rotation permitted within randomization parameters.

In addition, the present invention provides mouth movements of the avatar 710, which are synchronized to the audio stream 320 by utilizing a series of expandable mouth state graphics, including primary phonemes and closed-mouth states, which are triggered by amplitude data loaded into a mouth movie clip in an animation program, such as Flash®. The amplitude data moves the mouth movie clip to one of a dynamic number of frames every 1/12^{th} of a second. Each frame comprises a different mouth phoneme and the movement between frames based on amplitude produces the illusion of lip synchronization. It should also be noted that the present invention provides for unlimited speech times due to a scrubbing capability, as described in further detail below.

On occasion, it is particularly helpful to view product information in 3-D format. The present invention solves the need for 3-D graphics by having the capability to stream a 3-D graphic presentation format 720 (see FIG. 7), in addition to a standard graphic presentation format.

Referring back to FIG. 2, both the supplier computer resource 115 and the information provider computer resource 125 may comprise a Web site. Each Web site (supplier Web site 204 and information provider Web site 201) is further comprised of individual Web pages, e.g., an information provider Web page 210 and a supplier Web page 212. In addition, the information provider Web site preferably has the same look and feel as the supplier Web site. The same look and feel is accomplished by having a Web page background with headers, logos, colors, background patterns, and frames being the same as, or having a virtually indistinguishable similarity to, the headers, logos, colors, background patterns, and frames characteristic of the supplier Web site Web page 212. On the information provider Web page 210, the end user has the capability to select a product information presentation for streaming.

According to the present invention, the information provider Web page 210 may display a list box 715 of items, e.g., as shown in FIG. 7, or alternatively may display a text entry field 725. Presentation selection may then be achieved by selecting from the displayed list box 715, browsing by a first letter of a name 717, or entering text into the displayed text box 725. It should also be noted that for a presentation having sections, the end user can select from a section pulldown menu 910 (shown in FIG. 9) a particular section to play.

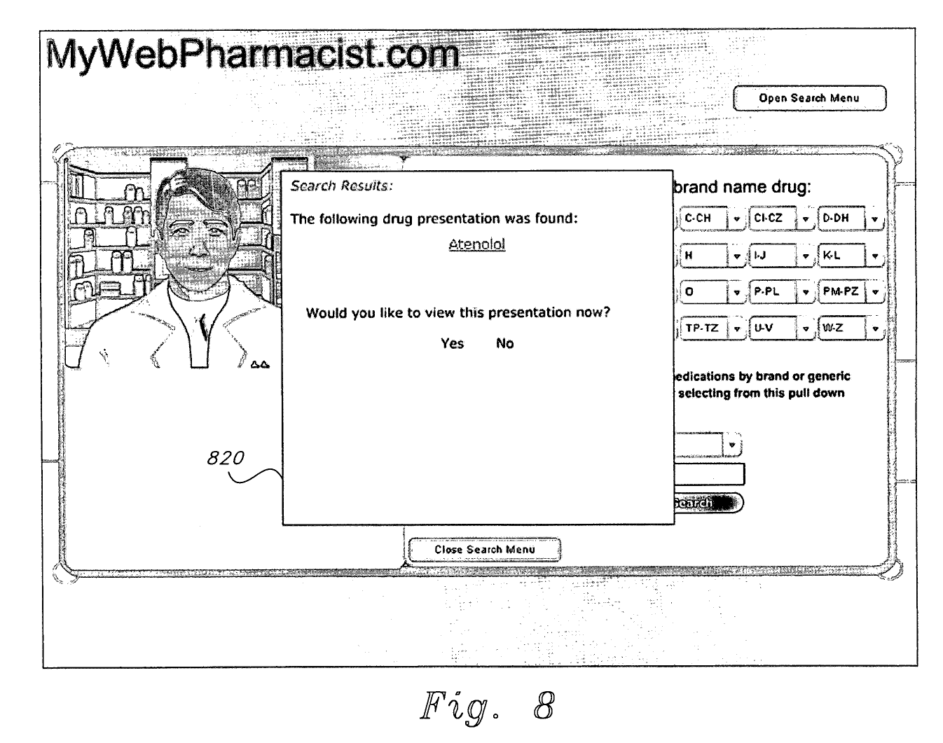

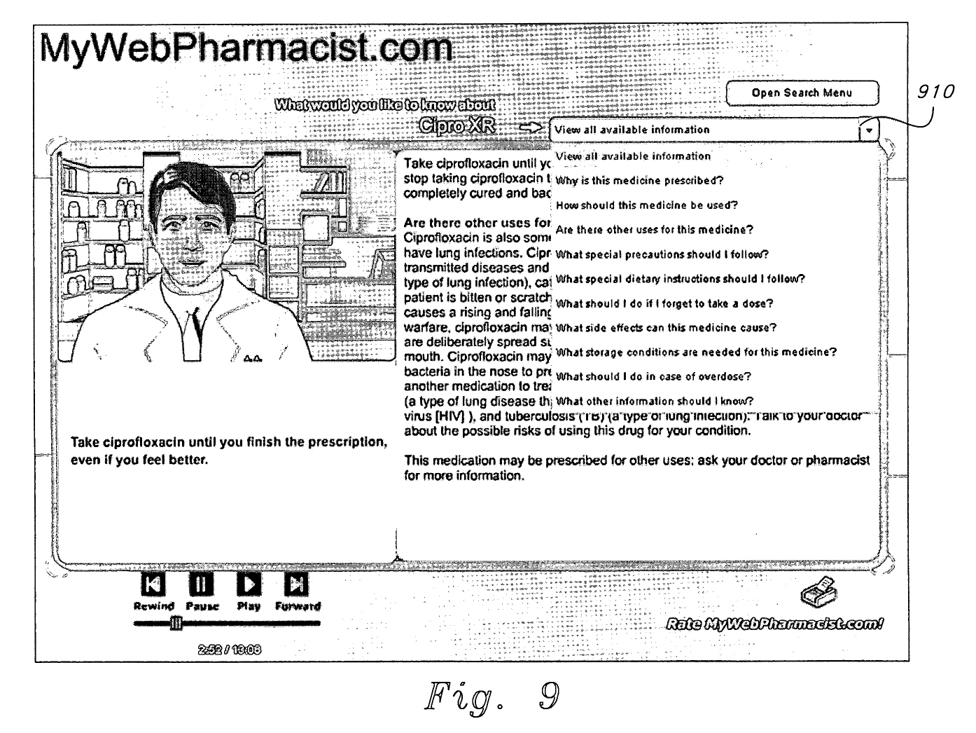

The present invention provides the option to initiate a presentation if the item entered by text is found in the database 140. For example, in the Web-based pharmacist of the present invention, if a drug entered in the text field and processed by a search engine 358 (shown in FIG. 3) yields a hit in the database 140, a search results dialog box 820 (shown in FIG. 8) presents the option to view the drug presentation about that particular drug, or to return to the selection field.

Referring to FIG. 7, the presentation stream can be initiated by end user selection of a play button 730. In addition, the end user can pause the stream by selecting a pause button 750, rewind the stream by selecting a rewind button 760, advance the stream by selecting a fast forward button 740, and scrub, i.e., randomly select a cue point in the stream without first downloading the stream up to the cue point by dragging a slider bar 770 to the desired point in the presentation. Additional selection options include the capability of printing out a text version of the at least one presentation responsive to a printout request by the end user.

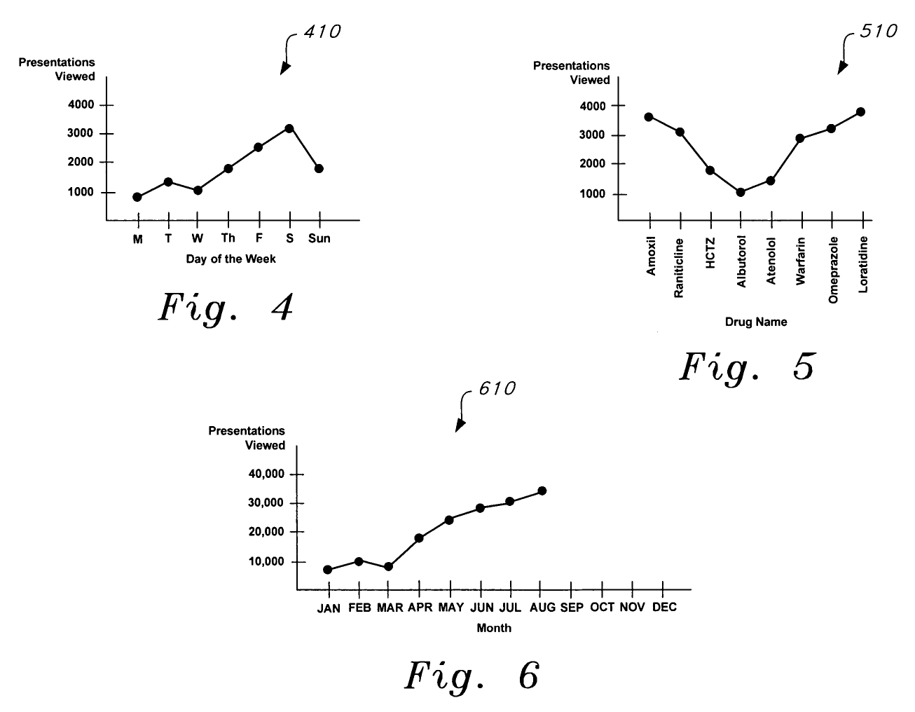

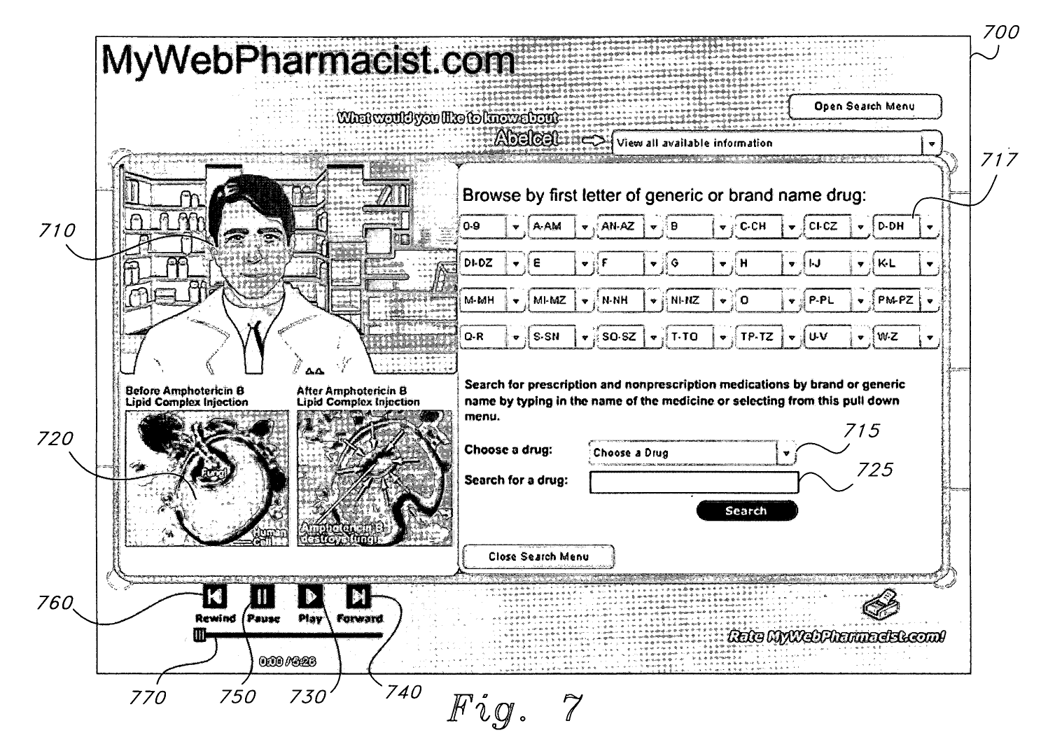

Within the computer resources of the information provider 125, the presentation platform 355 of the present invention possesses a function for collecting usage statistics of the end user 120 in a marketing database 395, which provides input to a report generator 398 for generating reports therefrom. Referring to FIGS. 4-6, it is shown that the present invention provides usage statistics including, but not limited to: (1) the aggregate number of presentations viewed by the end user 410; (2) the number of presentations viewed for each of a product or service 510; (3) the number of times each presentation section is viewed for any one of the products or services; and, (4) the day and time that the presentations were delivered to the end user 410, (time not shown).

These statistical data are processed to produce end user surveys to determine if the end user understood certain facts about the presentation. For example, in the Web-based pharmacist embodiment of the present invention, the end user survey determines if the end user understood how to use the drug presented in a drug presentation. Also, the statistical data may be processed by a report generator 398 to produce marketing intelligence for the supplier to determine supplier marketing effectiveness. For example, according to the present invention, an additional function is provided for tabulating end user Web site usage data, where the pharmacy may be permitted access to the data comprising: total number of end users per month; total number of distinct visitors per month; a complete listing of all drugs presented, in descending order; a complete listing of all drug sections viewed; a complete listing of sections viewed for each drug; type of internet connection used by end users to access the information provider; type of Internet browser used by the end user; number of times a multimedia presentation is downloaded on the information provider Web site; total number of times the drug information is printed; a complete listing of all drugs for which the drug information is printed; a complete listing of sections printed per drug; and, an average wait time for a drug presentation to download.

It is to be understood that the present invention is not limited to the embodiment described above, but encompasses any and all embodiments within the scope of the following claims.

I claim:

1. A computer-implemented method for the presentation of drug information related to a pharmacy, comprising the step of:
providing at least one link from a computing resource of the pharmacy, the link directing at least one end user to a computing resource of an information provider; and
presenting the end user with at least one drug presentation relating to a drug for sale by the pharmacy, the presentation being delivered using the computing resource of the information provider.

2. The computer-implemented method for the presentation of drug information related to a pharmacy as claimed in claim 1, further comprising the step of storing the drug presentation in a database.

3. The computer-implemented method for the presentation of drug information related to a pharmacy as claimed in claim 2, further comprising the step of retrieving the presentation from the database in response to a selection by the at least one end user.

4. The computer-implemented method for the presentation of drug information related to a pharmacy as claimed in claim 1, further comprising the step of presenting the drug presentation in an audio presentation format.

5. The computer-implemented method for the presentation of drug information related to a pharmacy as claimed in claim 1, further comprising the step of presenting the drug presentation in text format.

6. The computer-implemented method for the presentation of drug information related to a pharmacy as claimed in claim 1, further comprising the step of presenting the drug presentation in a graphical format.

7. The computer-implemented method for the presentation of drug information related to a pharmacy as claimed in claim 1, further comprising the step of presenting the drug information using an avatar.

8. The computer-implemented method for the presentation of drug information related to a pharmacy as claimed in claim 1, wherein the link is a hypertext URL link.

9. The computer-implemented method for the presentation of drug information related to a pharmacy as claimed in claim 1, wherein the computer resource of the pharmacy further comprises a pharmacy Web site.

10. The computer-implemented method for the presentation of drug information related to a pharmacy as claimed in claim 1, wherein the computer resource of the information provider further comprises an information provider Web site.

11. A Web-based pharmacist system, comprising:
a pharmaceutical supplier Web site;
an information provider Web site;
a database linked to the information provider Web site, the database having at least one presentation related to a pharmaceutical supplied by the pharmaceutical supplier; and
a Web page published on the pharmaceutical supplier Web site having a link to the presentation stored in the database linked to the information provider Web site;
wherein a consumer interested in the pharmaceutical is directed by the link on the pharmaceutical supplier's Web site to the information provider's Web site for retrieval and display of the presentation relating to the pharmaceutical.

12. The Web-based pharmacist system as claimed in claim 11, wherein said pharmaceutical supplier Web site and said information provider Web site are connected to the Internet, the drug presentation being accomplished over the Internet.

13. The Web-based pharmacist system as claimed in claim 11, wherein said pharmaceutical supplier Web site and said information provider Web site are connected to an intranet, the drug presentation being accomplished over the intranet.

14. The Web-based pharmacist system as claimed in claim 11, wherein said information provider Web site further comprises a presentation platform having an avatar processor, a text processor, a graphics processor, and a speech processor for streaming and synchronizing avatar, text, graphics, and speech components of the drug presentation.

15. The Web-based pharmacist system as claimed in claim 14, wherein the graphics processor further comprises means for streaming and synchronizing a 3-D graphic presentation format.

16. The Web-based pharmacist system as claimed in claim 14, wherein the speech processor further comprises:
means for outputting an audio stream having amplitude data for synchronizing mouth movements of the avatar; and
means for outputting an audio stream for an unlimited speech time.

17. The Web-based pharmacist system as claimed in claim 11, wherein the avatar processor further comprises:
means for randomizing avatar head turning;
means for randomizing avatar head rotation;
means for randomizing a length of pause before the avatar moves to a new head rotation sequence;
means for randomizing a number that triggers one of an expandable set of eyebrow animations;
means for determining an eye blink rate;
means for determining a minimum and maximum degree of head rotation permitted within randomization parameters;
means for achieving realistic facial movement in the avatar; and
means for synchronizing mouth movements of the avatar to the audio stream.

18. A computer-implemented method for the presentation of information related to a supplier comprising the steps of:
providing at least one link from a computing resource of the supplier, the link directing at least one end user to a computing resource of an information provider; and
presenting the end user with at least one presentation relating to a product for sale by the supplier, the presentation being delivered using the computing resource of the information provider.

19. The computer-implemented method for the presentation of information related to a supplier as claimed in claim 18, wherein the product for sale by the supplier comprises merchandise.

20. The computer-implemented method for the presentation of information related to a supplier as claimed in claim 18, wherein the product for sale by the supplier comprises services.
